(19) United States
(12) Patent Application Publication
(10) Pub. No.: US 2014/0345574 A1
(43) Pub. Date: Nov. 27, 2014

(54) TANK VENTING SYSTEM AND METHOD FOR DIAGNOSING SAME

(71) Applicant: Matthias Haefele, Gingen (DE)

(72) Inventor: Matthias Haefele, Gingen (DE)

(21) Appl. No.: 14/351,474

(22) PCT Filed: Sep. 19, 2012
(86) PCT No.: PCT/EP2012/068422

§ 371 Date: Apr. 11, 2014

(30) Foreign Application Priority Data
Oct. 13, 2011 (DE) 10 2011 084 403.1

(51) Int. Cl. F02M 25/08

(52) U.S. Cl. CPC F02M 25/0836; F02M 25/0818
USPC 123/519; 73/114.39

(57) ABSTRACT

A tank venting system of an internal combustion engine having an intake manifold, a fuel tank, and an activated carbon filter includes: a tank vent valve; at least one check valve; and a pressure sensor situated between the tank vent valve and the check valve. For diagnosing this tank venting system, a negative pressure which is lower than the ambient pressure outside the engine system is stored between the tank vent valve and the check valve. The stored pressure is changed by controlling the tank vent valve, and the change in the pressure is measured via the pressure sensor. The functioning of the tank venting line, of the check valve, and of the tank vent valve is deduced from the correlation of the opening state of the tank vent valve with the change in pressure.

### BACKGROUND OF THE INVENTION

1. Field of the Invention

The present invention relates to a tank venting system and to a method for diagnosing the tank venting system.

2. Description of the Related Art

Present internal combustion engines have tank venting systems in which fuel that has evaporated in the tank is stored in an activated carbon filter which is connected to the intake manifold of the internal combustion engine via a closable tank vent valve. When the tank vent valve is open, air is drawn in via a connection of the activated carbon filter to the environment, entraining the temporarily stored fuel and supplying it for combustion. The quantity of gas that is drawn in is controlled via the tank vent valve in such a way that on the one hand the activated carbon filter is sufficiently purged with air, and on the other hand, unacceptably large disturbances of the fuel/air ratio of the mixture supplied to the internal combustion engine do not occur.

In order to comply with regulatory requirements, a defective tank vent valve that is installed in a tank venting system must now be recognized as defective via suitable diagnoses. It is already known to open a tank vent valve during operation of the engine and to evaluate a response from a fuel/air ratio control loop for the diagnoses. The fuel vapor from the tank venting (regeneration gas) mixed with air causes a disturbance of the control loop, so that the occurrence of the disturbance indicates properly functioning tank ventilation, and thus in particular a properly functioning tank vent valve. This is described in published German patent application document DE 100 43 071 A1, for example.

It may be provided to repeatedly open the tank vent valve and to use a statistical analysis of a change in the mixture, which results from activating the valve and which is detected with the aid of a lambda sensor, for the diagnosis. This check may be made during idling and also during partial load operation of the internal combustion engine. In the process, the tank vent valve is slowly activated in a ramp-like manner without the overall system taking this activation into account. In other words, during the activation of the tank vent valve, the air and fuel components which are supplied to the engine via the tank vent valve are not taken into account. An intact or defective tank vent valve may be deduced via the response of the overall system to this occurring disturbance variable, which represents a mixture deviation. However, in the event that the mass flow which is conducted via the tank vent valve now contains no hydrocarbon molecules, i.e., when an unloaded activated carbon filter is “purged,” this does not result in a response from the lambda control after the tank vent valve is opened, and therefore it cannot be determined whether a defective tank vent valve is present. In other words, although the tank vent valve is properly activated, it is possible that no mixture deviation is determined, so that, as mentioned, a conclusion cannot be drawn concerning the functioning of the tank vent valve.

Charge detection is carried out with the aid of a hot film air mass sensor, for example. Charge detection with the aid of an intake manifold pressure sensor is also known. In this type of charge detection, the gas which is additionally introduced into the system and thus into the intake manifold via the tank vent valve is measured with the aid of an intake manifold pressure sensor.

In recent hybrid vehicles, the internal combustion engine is continually started and stopped. This makes it necessary to carry out the required diagnostic method for the tank venting system as quickly as possible so as not to hinder other diagnoses.

### BRIEF SUMMARY OF THE INVENTION

In the tank venting system according to the present invention, which includes an internal combustion engine having an intake manifold, a fuel tank, an activated carbon filter, a tank vent valve, and at least one check valve, a pressure sensor is situated between the tank vent valve and the check valve. The tank venting system according to the present invention may be used for naturally aspirated engines, for example. In this case, the tank venting system has a check valve. The tank venting system according to the present invention may also be used for supercharged engines. When the supercharged engines have an additional full load inlet point for the tank ventilation, the tank venting system according to the present invention usually has two check valves, namely, a check valve in each line which leads from the tank vent valve to the air supply system of the supercharged engine.

To design the tank venting system in a manner that is easy to install, according to the present invention it is preferred that the tank vent valve and at least one check valve have a one-piece design. In this case, a cavity in which the first pressure sensor is situated is present between the check valve and the tank vent valve. This preferred specific embodiment of the present invention is suitable for systems having a check valve in the tank venting line(s).

The functioning of the tank venting system, of the tank venting line, and of the check valves may be easily diagnosed in the tank venting system according to the present invention. For this purpose, according to the present invention a method is provided in which a negative pressure pₗ which is less than ambient pressure pᵤ outside the tank venting system is stored between the tank vent valve(s) and the check valve. The lowest value that pressure p₁ may assume corresponds to the lowest value that pressure p₂ in the intake manifold of the internal combustion engine may assume. When the tank vent valve is closed, the negative pressure results in closing of the check valves, and remains constant when the tank venting lines and valves are intact. The stored pressure may be changed in a targeted manner by controlling the tank vent valve. The change in the pressure between the tank vent valve and the check valve is measured via the first pressure sensor and associated with the control of the tank vent valve. The functioning of the tank venting lines, of the check valves, and of the tank vent valve is deduced from the correlation of the opening state of the tank vent valve with the change in pressure pₗ between the tank vent valve and the check valve. According to the present invention, a correlation is understood to mean a causal relationship between the opening state of the valve and the change in pressure.

The diagnostic method according to the present invention may be used when the internal combustion engine is switched off, when the internal combustion engine is started, and when the internal combustion engine is running. When the internal combustion engine is switched off, according to the present invention it is preferred that the tank vent valve is opened and subsequently reclosed when pressure pₗ, measured by the pressure sensor, between the tank vent valve and the check valve is not equal to ambient pressure pᵤ. For this purpose, the ambient pressure is measured outside the tank venting system via a further sensor. After the tank vent valve is closed, an upward sensor drift is recognized if pressure p₁ is greater than the sum of ambient pressure pᵤ and an error threshold. If pressure pₗ is less than the sum of ambient pressure pᵤ and an error threshold after the tank vent valve is closed, a check is initially made as to whether the internal combustion engine has been switched off for a long or for a short time prior to the diagnosis. According to the present invention, a long switched-off period is considered to be a time period in which a negative pressure p₁ which has been stored prior to switching off the internal combustion engine usually returns to ambient pressure pᵤ. This value is a function of the seal-tightness of the check valves and the stored pressure difference between pₗ and pᵤ when the internal combustion engine is switched off. According to the present invention, a time period that exceeds a fixed time period t is usually considered to be a long switched-off period, and a time period having a maximum value of fixed time period t is considered to be a short switched-off period. Fixed time period t is the time during which pressure p₁ is less than the ambient pressure, when the check valves and the tank vent valve are intact. This time period t may be ascertained by measurement, and may subsequently be stored in a computer program, for example. For a long switched-off period after the tank vent valve has been closed, if it is recognized that measured pressure p₁ is less than a setpoint pressure p₁ₛ which is ascertained over the switched-off period on the basis of the difference of pressure pₗ the last time the internal combustion engine was switched off with respect to ambient pressure pᵤ, the curve of p₁ is measured when the internal combustion engine is started, and a downward sensor drift is recognized if at any point in time during the starting operation, p₁ is less than pressure p₂ in the intake manifold of the internal combustion engine by an error threshold, and at the end of the starting operation is less than minimum achieved pressure p₂. For this purpose, pressure p₂ is measured via a further pressure sensor in the intake manifold of the internal combustion engine, or is ascertained with the aid of the intake manifold pressure model which is computed using the air mass flow of a hot film air mass sensor. For a short switched-off period, if pressure p₁ is less than a setpoint pressure pₗₛ which is ascertained over the switched-off period after the tank vent valve is closed on the basis of the difference of pressure p₁ at the last time the internal combustion engine was switched off and ambient pressure pᵤ, the curve of p₁ is likewise measured when the internal combustion engine is started, and a downward sensor drift is recognized if at any point in time during the starting operation, pₗ is less than pressure p₂ in the intake manifold by an error threshold, and at the end of the starting operation is less than minimum pressure p₂. In addition, at the end of the starting operation of the internal combustion engine, the tank vent valve may be opened and reclosed when pressure p₂ is less than ambient pressure pᵤ, and a blockage of the tank vent valve is deduced when pressure p₁ does not increase to pressure p₂. These method steps according to the present invention allow a diagnosis of the tank vent valve, of the check valves, and of the inlet point into the intake manifold directly during starting of the internal combustion engine, which allows the time period of operation of the internal combustion engine to be utilized for other diagnoses, and does not require intentional starting of the internal combustion engine just for diagnoses of the tank venting system.

According to the present invention, it is further preferred that when the internal combustion engine is started, a check is made as to whether measured pressure p₁ is not equal to pressure p₂ in the intake manifold of the internal combustion engine. In this case, it is recognized that the line between the pressure sensor and the inlet point of the tank venting line into the air supply system of the internal combustion engine is interrupted when pressure pₗ is equal to ambient pressure pᵤ. If pressure p₁ is less than ambient pressure pᵤ and is greater than pressure p₂ in the intake manifold, and pressure p₁ is equal to pressure p₂ plus an offset during continued operation of the internal combustion engine, the result of the diagnosis is a function of the magnitude of the offset. For this purpose, a lower limiting pressure p₁ᵤ is defined as pressure pₗ which is measured at the pressure sensor when the tank vent valve is open and the line between the tank vent valve and the check valve(s) is intact. An upper limiting pressure pₗₒ, is defined as the pressure which is measured at the pressure sensor when the valves are intact but the line between the tank vent valve and the check valve(s) has fallen off. These pressures are different, since the mass flow which flows via the tank venting lines into the intake manifold of the internal combustion engine when an open tank vent valve and intact tank venting lines are present is less than the mass flow into the intake manifold only via the tank venting lines when the line has fallen off. When the tank vent valve is open, this results in a greater throttle effect and thus a lower pressure p₁ than when the line between the tank vent valve and the pressure sensor has fallen off. Lower limiting pressure p₁ᵤ may be computed from pressure p₂ in the intake manifold and the throttle factor of the open tank vent valve. Upper limiting pressure pₗₒ, may be computed from pressure p₂ in the intake manifold and the throttle factor when the line between the tank vent valve and the pressure sensor has fallen off. For a pressure pₗ that is greater than lower limiting pressure pₗᵤ and less than or equal to upper limiting pressure pₗₒ (large offset), it is recognized that the pressure line between the pressure sensor and the tank vent valve is defective. For a pressure pₗ that is less than or equal to lower limiting pressure p₁ᵤ (small offset) and greater than intake manifold pressure p₂, in an engine system having an inlet point (inlet point into the intake manifold) it is recognized that the tank vent valve is open. In an engine system having two inlet points (inlet point into the intake manifold and full load inlet point of a supercharged engine), it is recognized that the check valve of the full load inlet point is defective if a pressure jump occurs when the tank vent valve is energized, and that the pressure line between the pressure sensor and the tank vent valve is defective if no pressure jump occurs when the tank vent valve is energized. These method steps allow a diagnosis of the tank venting system even during starting of the internal combustion engine and operation of the internal combustion engine without purge volume losses.

If during operation of the internal combustion engine no pressure jumps in pressure pₗ occur when the tank vent valve is opened and subsequently closed, this indicates a defect in the tank venting system. During engine operation with natural aspiration, i.e., when pressure p₂ in the intake manifold of the internal combustion engine is less than ambient pressure pᵤ, in this case five different defects may be recognized. If the tank vent valve has already been recognized as defective, it is additionally recognized that the tank vent valve is jammed open if pressure pₗ is less than or equal to lower limiting pressure pₗᵤ and greater than intake manifold pressure p₂. If a diagnosis of the tank vent valve is not possible, a line defect between the tank vent valve and the pressure sensor is recognized if pressure pₗ is greater than lower limiting pressure p₁ᵤ and less than or equal to upper limiting pressure p₁ₒ. If a diagnosis of the tank vent valve is not possible, a line defect between the intake manifold and the pressure sensor is recognized if pressure pₗ is equal to ambient pressure pᵤ. If pressure p₁ is less than or equal to pressure p₂ in the intake manifold and remains at minimum stored intake manifold pressure p₂, it is recognized that the tank vent valve is jammed shut. If pressure p₁ is equal to pressure p₂, it is recognized that the tank vent valve is jammed shut and the check valve is defective. For a positive pressure in the intake manifold, i.e., when pressure p₂ in the intake manifold is greater than ambient pressure pᵤ, three different defects may be recognized. If pressure p₁ drops with increasing pressure p₂, it may be recognized, as a function of the change in pressure p₁ with respect to ambient pressure pᵤ, whether the tank vent valve is jammed open or jammed shut. If pressure pₗ is equal to ambient pressure pᵤ when the tank vent valve is closed, it is recognized that the full load venting line is defective (this occurs only in supercharged engines having full load tank venting). If pressure p₁ is greater than ambient pressure pᵤ, and pressure p₁ is correlated with pressure p₂, it is recognized that the check valve is defective.

The method according to the present invention also allows a check of the line between the tank vent valve and the inlet point into the intake manifold when the internal combustion engine is running. If the tank vent valve is closed during operation of the internal combustion engine, pressure p₁ is less than or equal to pressure p₂ in the intake manifold, and pressure p₂ is less than the ambient pressure, three different defects may be recognized. Falling off of the line is recognized if pressure pₗ is equal to ambient pressure pᵤ. A downward sensor drift of the pressure sensor is recognized if measured pressure p₁ is continuously less than pressure p₂ by an offset. The check valve is recognized as jammed open if pressure p₁ is equal to pressure p₂ with increasing pressure p₂. When the tank vent valve is open, it is recognized that the line between the tank vent valve and pressure sensor p₁ has fallen off if pressure p₁ is greater than lower limiting pressure p₁ᵤ and less than or equal to upper limiting pressure p₁ₒ. If pressure p₁ is less than or equal to lower limiting pressure pₗᵤ and greater than intake manifold pressure p₂, it is recognized that the tank vent valve is open and that the line between the intake manifold and the tank vent valve is intact. If pressure p₁ is equal to ambient pressure pᵤ, it is recognized that the line between the tank vent valve and the pressure sensor has fallen off.

In addition, by use of the method according to the present invention, a check of the line between the tank vent valve and the full load inlet point is possible during operation of an internal combustion engine having two tank venting inlet points. For this purpose, during operation of the internal combustion engine with the tank vent valve closed, if intake manifold pressure p₂ increases from a value that is less than ambient pressure pᵤ to a value that is greater than ambient pressure pᵤ, and if pressure p₁ is less than ambient pressure pᵤ, pressure pₗ is increased to ambient pressure pᵤ by opening and closing the tank vent valve. If pressure p₂ in the intake manifold is greater than ambient pressure pᵤ, and pressure p₁ corresponds to ambient pressure pᵤ, it is recognized that the line between the full load inlet point and the pressure sensor is defective. If pressure p₂ in the intake manifold is greater than ambient pressure pᵤ, and pressure pₗ corresponds to a pressure pᵥ at the Venturi nozzle, it is recognized that the tank vent valve is jammed shut. Pressure pᵥ at the Venturi nozzle may be ascertained with the aid of the Bernoulli equation. If pressure p₂ in the intake manifold is greater than ambient pressure pᵤ, and pressure p₁ is greater than lower limiting pressure p₁ᵤ and less than or equal to upper limiting pressure pₗₒ, it is recognized that the line between the tank vent valve and the pressure sensor is defective. If pressure p₂ in the intake manifold is greater than ambient pressure pᵤ, and pressure pₗ is greater than ambient pressure pᵤ, it is recognized that a check valve is defective. If the tank vent valve is open or closed at a pressure p₂ in the intake manifold which is greater than ambient pressure pᵤ and no pressure jump to pₗ is measurable, it is recognized that the tank vent valve is defective. When the tank vent valve is jammed open, pressure p₁ corresponds to lower limiting pressure pᵤ, and when the tank vent valve is jammed shut, pressure pₗ corresponds to pressure pᵥ at the Venturi nozzle.

In addition, the method according to the present invention allows a check of the check valves during operation of the internal combustion engine. Prior to switching off the internal combustion engine, the tank vent valve is closed in order to store pressure p₂ in the intake manifold between the tank vent valve and the check valve as pressure pₗ between the tank vent valve and the check valve(s). After closing the tank vent valve, if an increase in pressure p₁ is measured and the tank vent valve and the line have been assessed as defect-free, three defect diagnoses are possible. It is recognized that the check valve of the inlet point in the intake manifold is defective if pressure pₗ is always equal to pressure p₂, provided that pressure p₂ is less than ambient pressure pᵤ. If pressure p₁ is always greater than pressure p₂ and less than ambient pressure pᵤ, it is recognized that the check valve of the line between the tank vent valve and the full load inlet point is defective. In addition, with the aid of pressure pₗ which is stored during the shutoff operation, it may once again be checked whether the tank vent valve is functioning by opening the tank vent valve at an intake manifold pressure p₂ that is equal to ambient pressure pᵤ, with the internal combustion engine switched off. Stored pressure pₗ, which is less than ambient pressure pᵤ, jumps to ambient pressure pᵤ when the tank vent valve is functioning. If no change in pressure is apparent, it is recognized that the tank vent valve is jammed shut.

Moreover, the present invention relates to a computer program which executes all steps of the method according to the present invention when it runs on a computer. This allows the simple implementation of the method according to the present invention in the diagnostic electronics system of a motor vehicle which is present anyway. Lastly, the present invention relates to a computer program product having program code, stored on a machine-readable medium, for carrying out the method according to the present invention when the program is executed on a computer or a control unit.

### BRIEF DESCRIPTION OF THE DRAWINGS

FIG. 1 shows a tank venting system according to the present invention, having a tank venting inlet point for engine operation with natural aspiration.

FIG. 2 shows one specific embodiment of a tank venting system according to the present invention, having a tank venting inlet point for engine operation with natural aspiration, the tank vent valve and the check valve having a one-piece design.

FIG. 3 shows one specific embodiment of a tank venting system according to the present invention, having two tank venting inlet points for engine operation with natural aspiration and full load tank venting.

FIG. 4 shows another specific embodiment of a tank venting system according to the present invention, having two tank venting inlet points for engine operation with natural aspiration and full load tank venting.

FIG. 5 shows yet another specific embodiment of a tank venting system according to the present invention, having two tank venting inlet points for engine operation with natural aspiration and full load tank venting.

### DETAILED DESCRIPTION OF THE INVENTION

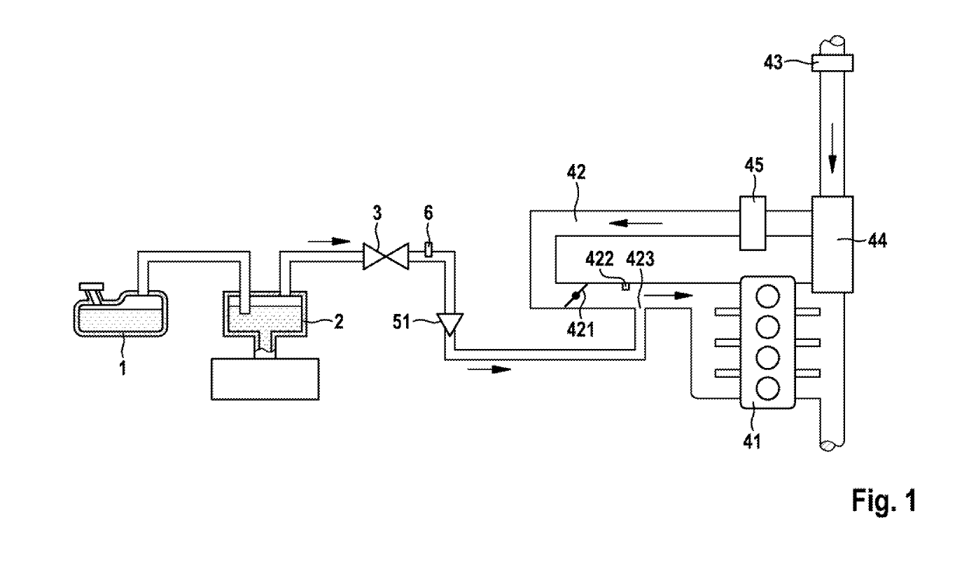

FIG. 1 shows a tank venting system according to a first specific embodiment of the present invention. A fuel tank 1 is connected to an activated carbon filter 2. A line leads from activated carbon filter 2 to a tank vent valve 3. A line leads from this tank vent valve 3 to intake manifold 42 of an internal combustion engine 41. A check valve 51 which allows transport of fluids only in the direction of intake manifold 42 is situated in this line. A pressure sensor 6 is situated between tank vent valve 3 and check valve 51. Ambient air is transported into a turbocharger 44 via an air filter 43. From there, the air is relayed into intake manifold 42 via a charge air cooler 45. A throttle valve 421 and an intake manifold pressure sensor 422 are situated in the intake manifold. The intake manifold is connected to internal combustion engine 41.

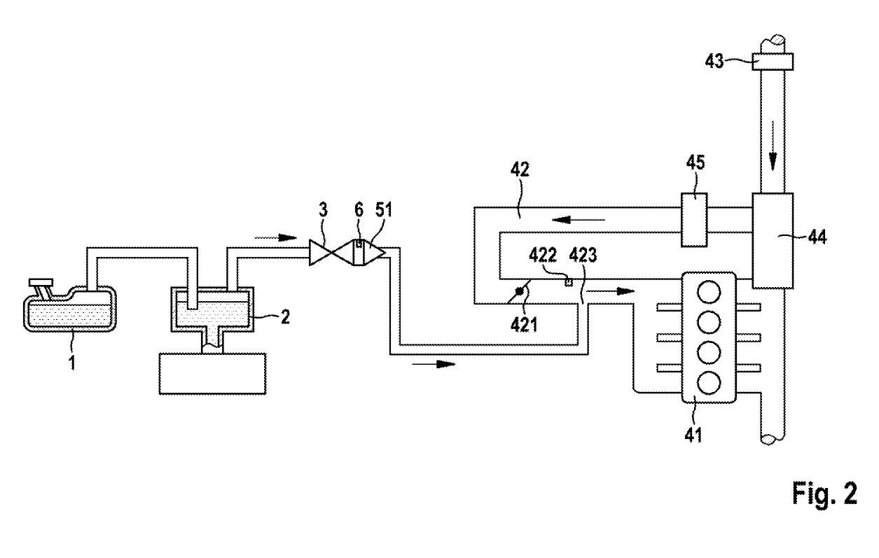

FIG. 2 shows a second specific embodiment of the present invention. In contrast to the first specific embodiment, tank vent valve 3, check valve 51, and pressure sensor 6 have a one-piece design in this present specific embodiment. The combined component has a cavity, between tank vent valve 3 and check valve 51, in which pressure sensor 6 is situated and in which negative pressure may be stored. This cavity has a volume in particular of at least 1 cm³.

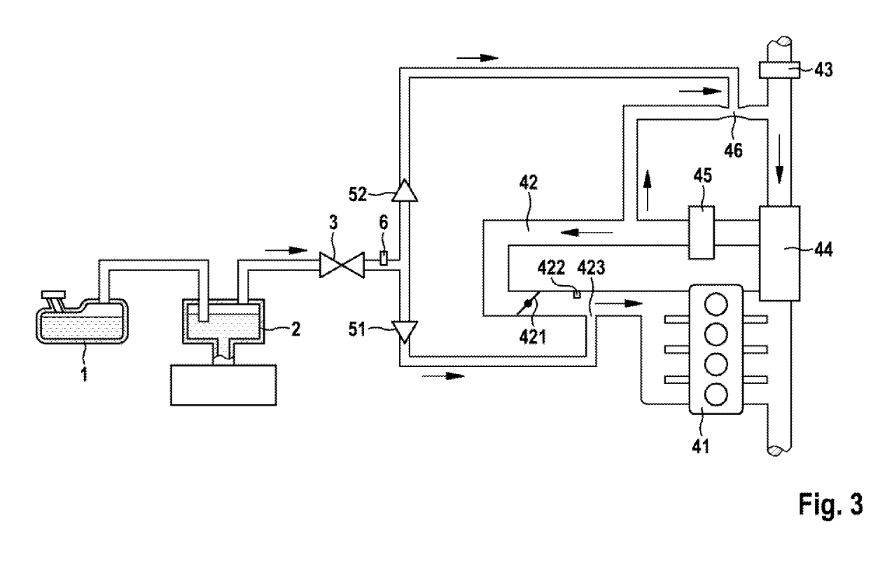

FIG. 3 shows a third specific embodiment of the present invention. In this specific embodiment, a full load line branches off from the tank venting line between tank vent valve 3 and first check valve 51 (which corresponds to check valve 51 in the first specific embodiment), the full load line ending in a Venturi nozzle 46 as a full load inlet point. A second check valve 52 is situated in the full load line. This second check valve 52 prevents fluid transport in the full load line in the direction of tank vent valve 3. An additional line which likewise ends in Venturi nozzle 46 branches off from intake manifold 42. Venturi nozzle 46 is connected to the air inlet line between air filter 43 and turbocharger 44.

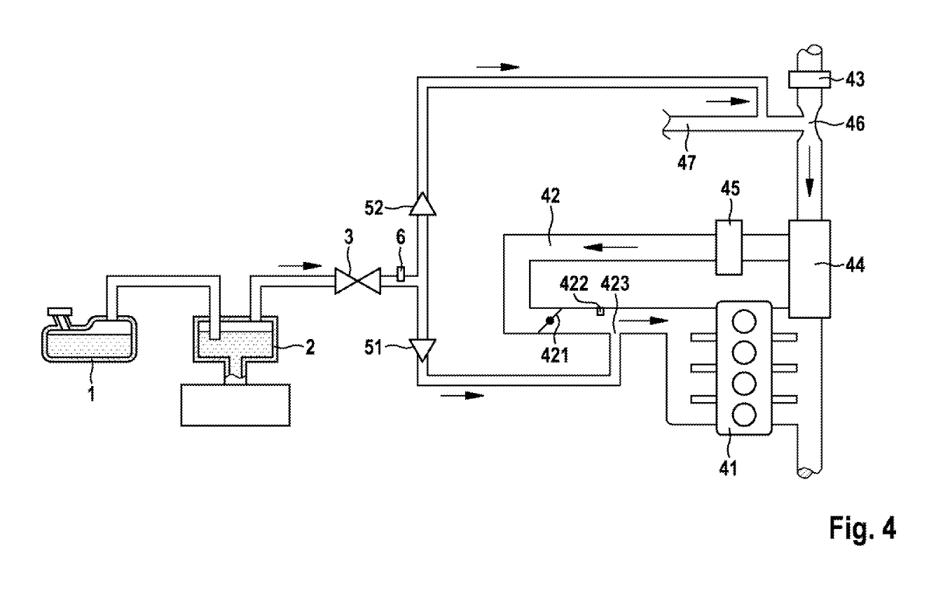

FIG. 4 shows a fourth specific embodiment of the present invention. This specific embodiment differs from the third specific embodiment in that the Venturi nozzle is situated in the line between air filter 43 and turbocharger 44. There is no line which branches off from intake manifold 42 and ends in Venturi nozzle 46. A crankcase venting line 47 opens into the full load line. Crankcase venting line 47 is connected to internal combustion engine 41. This connection is not shown.

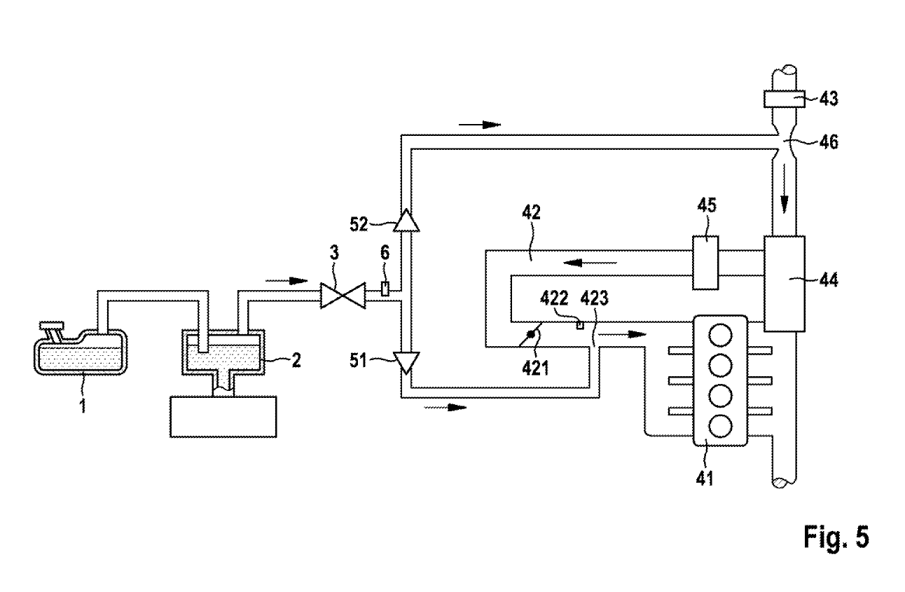

FIG. 5 shows a fifth specific embodiment of the present invention. This specific embodiment differs from the fourth specific embodiment in that there is no crankcase venting line 47 that opens into the full load line.

In the tank venting systems according to the first through fifth specific embodiments of the present invention, various check paths are possible for diagnosing the tank venting systems.

When the internal combustion engine is switched off, electrically controllable tank vent valve 3 is usually not energized, and is in the closed state. If a pressure pₗ between tank vent valve 3 and check valve(s) 51, 52 essentially corresponds to ambient pressure pᵤ, i.e., the pressure in tank 1, a diagnosis may be begun when internal combustion engine 41 is started. Otherwise, according to the present invention, diagnoses are necessary prior to starting the internal combustion engine. In this case, tank vent valve 3 is briefly opened and reclosed before the engine is started, so that pressure pₗ becomes equal to ambient pressure pᵤ, i.e., the pressure in tank 1. If pressure p₁ is unchanged after controlling the tank vent valve, it is recognized that the tank vent valve is jammed shut. In both cases, before the engine is started, it is ascertained whether a plausible pressure p₁ is present, based on measured pressure p₁ and with the aid of the pressure difference of pressure p₁ and ambient pressure pᵤ that is present over a pressure loss curve as a function of the switched-off period of the internal combustion engine and present when the engine is switched off, and by how much this pressure pₗ deviates from a computed setpoint value p₁ₛ of pressure p₁. If pressure p₁ is greater than p₁ₛ and or less than or equal to ambient pressure pᵤ, it is recognized that a leak is present at at least one of check valves 51, 52, at tank vent valve 3, or at the line between tank vent valve 3 and check valves 51, 52. To distinguish these defects, as an additional check the signal curve of pressure p₁ as well as the change in pressure p₁ are analyzed by opening and closing tank vent valve 3 when the internal combustion engine is running. If pressure p₁ is greater than pₗₛ and greater than ambient pressure pᵤ, the sensor signal of pressure sensor p₁ is implausible, and it is recognized that an upward sensor drift is present. If pressure p₁ is less than p₁ₛ, a downward pressure sensor drift p₁ is recognized. In this case, an additional check of the signal curve of pressure pₗ is made when the engine is started. When the internal combustion engine is started and tank vent valve 3 is not energized, if pressure sensor 6 indicates a pressure pₗ which is less than or equal to pressure p₂ in intake manifold 42 and which after a preset point in time drops to minimum pressure p₂ in intake manifold 42, it is recognized that pressure sensor 6 is not defective. In this case, tank vent valve 3 is opened and reclosed if pressure p₂ is less than ambient pressure pᵤ. However, if the tank venting system to be diagnosed has a second inlet point of a full load venting according to FIG. 3, tank vent valve 3 may then also be opened and closed if pressure p₂ is greater than ambient pressure pᵤ. If no pressure jumps in pressure p₁ can be determined, it is recognized that tank vent valve 3 is jammed in the closed state.

The curve of pressure pₗ is compared to the curve of pressure p₂ when internal combustion engine 41 is started. If pₗ is always less than or equal to p₂ and drops to the minimum value of p₂ after a preset time period, the tank venting line to first inlet point 423 into intake manifold 42 is present and intact, and check valves 51, 52 are operating properly, and tank vent valve 3 is closed. In this case, no further diagnosis is necessary during starting of the engine. However, if the curve of pressure p₁ is not equal to the curve of pressure p₂, and pressure pₗ corresponds to ambient pressure pᵤ, it is established that the tank venting line between pressure sensor 6 and inlet point 423 is interrupted. If the curve of pressure pₗ does not correspond to the curve of pressure p₂, and pressure p₁ is less than ambient pressure pᵤ and greater than pressure p₂, the curve of pressure p₁ is analyzed during continued operation of internal combustion engine 41. If the curve of pressure p₁ essentially corresponds to pressure p₂ during continued operation of internal combustion engine 41 with natural aspiration, based on an assessment of the offset distance between p₁ and p₂ it is possible to deduce two error paths. For this purpose, a lower limiting pressure pₗᵤ, is defined as pressure pₗ which is measured at the pressure sensor when the tank vent valve is open and the line between the tank vent valve and the check valve(s) is intact. An upper limiting pressure pₗₒ is defined as the pressure which is measured at the pressure sensor when the valves are intact but the line between the tank vent valve and the check valve(s) has fallen off. If pressure pₗ corresponds to the curve of upper limiting pressure pₗₒ or is between upper limiting pressure p₁ₒ and lower limiting pressure pₗᵤ, the line between pressure sensor 6 and tank vent valve 3 is defective. If pressure p₁ is less than or equal to p₁ᵤ, tank vent valve 3 is jammed in the open state. If pressure pₗ is greater than lower limiting pressure p₁ᵤ and less than ambient pressure pᵤ, and pressure jumps at p₁ are apparent due to energization of tank vent valve 3, check valve 52 is defective. Provided that an additional inlet point of the tank venting system according to FIGS. 3 through 5 is present at a Venturi nozzle 46 or negative pressure source, an appropriate diagnosis may likewise be carried out at an intake manifold pressure p₂ that is greater than ambient pressure pᵤ. If intake manifold pressure p₂ is greater than ambient pressure pᵤ, and pressure p₁ is greater than lower limiting pressure p₁ᵤ and less than or equal to upper limiting pressure pₗₒ, the line between pressure sensor 6 and tank vent valve 3 is defective. If intake manifold pressure p₂ is greater than ambient pressure pᵤ, and pressure pₗ is less than or equal to lower limiting pressure pₗᵤ and greater than pressure pᵥ at Venturi nozzle 46, tank vent valve 3 is jammed open. If pressure p₁ is greater than ambient pressure pᵤ, check valve 51 is defective. In the cases in which intake manifold pressure p₂ is not equal to ambient pressure pᵤ, it is deduced that the line between the pressure sensor and the intake manifold inlet point or Venturi inlet point has fallen off if pressure p₁ is equal to ambient pressure pᵤ.

During operation of internal combustion engine 41, with the aid of the method according to the present invention a check is made of tank vent valve 3, of the line between tank vent valve 3 and inlet point 423 of intake manifold 42, of the line between tank vent valve 3 and full load inlet point 46, and of check valves 51, 52. The check of tank vent valve 3 may be made during engine operation with natural aspiration (p₂<pᵤ) and also in the event of positive pressure in intake manifold 42 (p₂>pᵤ). The functioning of tank vent valve 3 may be checked by assessing the signal curve of pressure p₁ as a function of p₂, or by opening and reclosing the tank vent valve. If pressure jumps in pressure p₁ are detectable during opening and closing of the tank vent valve, it is established that tank vent valve 3 is not defective, and that the line between tank vent valve 3 and inlet point 423 of intake manifold 42 is likewise not defective. In contrast, if no pressure jumps are apparent, pressure pₗ is assessed based on pressures p₁ᵤ and p₁ₒ as a function of intake manifold pressure p₂ (signal curve of pressure pₗ with respect to pressure p₂). It may thus be established either that the line between tank vent valve 3 and inlet point 423 of intake manifold 42 is operating properly and tank vent valve 3 is jammed in the open state, or that a diagnosis of tank vent valve 3 is not possible due to the fact that the line between tank vent valve 3 and pressure sensor 6 has fallen off. If no pressure jumps are apparent and the signal curve of pressure pₗ is below the signal curve of pressure p₂ or corresponds to same, it is established that tank vent valve 3 is jammed in the closed state, and the line between tank vent valve 3 and inlet point 423 in intake manifold 42 is operating properly. If pressure p₁ is below pressure p₂, it may also be established that check valve 51 in the specific embodiments according to FIG. 1 and FIG. 2, or the two check valves 51, 52 in the specific embodiment according to FIGS. 3 through 5, is/are not defective. In the event of positive pressure in intake manifold 42, a check is made as to whether pressure jumps in pressure p₁ are verifiable by opening and closing tank vent valve 3, or whether pressure pₗ is equal to pressure pᵥ at Venturi nozzle 46 when tank vent valve 3 is not energized (closed), and pressure pₗ is equal to lower limiting pressure pₗᵤ when tank vent valve 3 is energized (open). If this is the case, tank vent valve 3 is not defective. In the specific embodiments according to FIGS. 3 through 5, the line between tank vent valve 3 and Venturi nozzle 46 also is not defective. In contrast, if no pressure jumps are apparent, or pressure pₗ deviates from pᵥ at Venturi nozzle 46 or from lower limiting pressure p₁ᵤ, the signal curve of pressure p₁ is assessed. A correlation of pressure pₗ as a function of pressure p₂ is made. If pressure p₁ drops with increasing pressure p₂, it is established that the line between tank vent valve 3 and Venturi nozzle 46 is not defective. As a function of the change in pressure p₁ with respect to ambient pressure pᵤ, it may be deduced whether tank vent valve 3 is jammed in the open state or is jammed in the closed state. In both cases, a defect of tank vent valve 3 is deduced. If pressure p₁ is less than or equal to lower limiting pressure p₁ᵤ and greater than pressure pᵥ at Venturi nozzle 46, the tank vent valve is jammed open. If pressure p₁ is equal to pressure pᵥ at Venturi nozzle 46, the tank vent valve is jammed shut. If no pressure jumps in pressure p₁ are recognizable, and pressure p₁ also corresponds to ambient pressure pᵤ when tank vent valve 3 is open, it is recognized that the line between tank vent valve 3 and Venturi nozzle 46 is defective. If pressure p₂ is greater than ambient pressure pᵤ, and a positive pressure is measured at pressure sensor 6 which correlates with pressure p₂ when tank vent valve 3 is closed, and is less than pressure p₂ by an offset when tank vent valve 3 is open, i.e., pressure jumps are recognizable also during opening and closing of tank vent valve 3, it is established that check valve 51 is defective.

According to the present invention, the check of the line between tank vent valve 3 and inlet point 432 into intake manifold 42 is made when tank vent valve 3 is closed and also when tank vent valve 3 is open. If the pressure curve of pressure pₗ is below the pressure curve of pressure p₂ or corresponds to same when tank vent valve 3 is closed, if pressure p₂ is less than the ambient pressure, the line between tank vent valve 3 and inlet point 423 into intake manifold 42 is not defective. If pressure pₗ adapts to a pressure that corresponds to minimum achieved pressure p₂, check valves 51, 52 likewise are not defective. However, if pressure p₁ corresponds to ambient pressure pᵤ, it is established that the line between tank vent valve 3 and inlet point 423 into intake manifold 42 has fallen off. If the pressure curve of measured pressure pₗ is continuously less than pressure p₂ by an offset and follows the change in pressure p₂, i.e., after a preset time period, pressure sensor 6 detects a pressure pₗ that is less than minimum achievable pressure p₂, a defect in first pressure sensor 6 is recognized, namely, a downward sensor drift. If the curve of pressure pₗ corresponds to that of pressure p₂ when pressure p₂ increases, it is established that check valve 51 is jammed in the open state.

Pressures p₂ and p₁ are assessed when tank vent valve 3 is open. If pressure p₁ is greater than pressure p₂, and the difference between pₗ and p₂ decreases with increasing intake manifold pressure p₂, it is established that the line between tank vent valve 3 and inlet point 423 into intake manifold 42 is not defective. This check is made when intake manifold pressure p₂ is less than ambient pressure pᵤ. If the pressure difference between p₁ and p₂ does not decrease with increasing pressure p₂, it is established that an upward sensor drift of pressure sensor 6 is present. If pressure p₁ is less than or equal to upper limiting pressure p₁ₒ and greater than lower limiting pressure p₁ᵤ, the line between tank vent valve 3 and pressure sensor 6 is defective. If pressure pₗ is less than or equal to lower limiting pressure p₁ᵤ and greater than negative pressure pᵥ at Venturi nozzle 46, tank vent valve 3 is open. This is based on the fact that tank vent valve 3 has a throttle effect even in the open state, and if the line to tank vent valve 3 downstream from pressure sensor 6 has fallen off, a much higher pressure curve is therefore still measurable than when tank vent valve 3 is open and the line is intact.

In the tank venting system according to FIG. 3, a check is also made of the line between tank vent valve 3 and full load inlet point 46 when internal combustion engine 41 is running. This check is possible only when pressure p₂ is greater than ambient pressure pᵤ. Tank vent valve 3 may be opened for the check and reclosed, or the signal curve of pressure sensor 6 is assessed when the tank vent valve is open or closed. If a pressure jump in pressure p₁ is measured, it is established that tank vent valve 3 is operating properly, and also that the line from tank vent valve 3 to full load venting 46 is operating properly. A line check is made as a function of the measurable pressure curve. In the event that pressure pₗ is less than ambient pressure pᵤ and also less than the maximum pressure that is generatable by Venturi nozzle 46, during the transition from naturally aspirated operation, in which pressure p₂ is less than ambient pressure pᵤ, into supercharged operation, in which pressure p₂ is greater than ambient pressure pᵤ, negative pressure pₗ must be reduced when pressure p₂ essentially corresponds to ambient pressure pᵤ. For this purpose, tank vent valve 3 must be briefly opened. Pressure pₗ then essentially corresponds to ambient pressure pᵤ. If tank vent valve 3 is now closed, a pressure p₁ results, as a function of pressure p₂, which is less than ambient pressure pᵤ. This indicates that the line between tank vent valve 3 and Venturi nozzle 46 is not defective, and also that check valve 51 is not defective. Check valve 52 is likewise not defective, provided that pressure pₗ remains constant when pressure p₂ drops to ambient pressure pᵤ. When tank vent valve 3 is open, pressure p₁ is equal to ambient pressure pᵤ during the transition from naturally aspirated operation into charge pressure operation. If pressure p₂ increases above ambient pressure pᵤ, pressure pₗ once again drops. Pressure pₗ is a function of intake manifold pressure p₂ and negative pressure pᵥ of Venturi nozzle 46 which is generated by intake manifold pressure p₂, and is therefore computed as lower limiting pressure p₁ᵤ as a function of intake manifold pressure p₂, using characteristic curves. Pressure pₗ which is measured at pressure sensor 6 when the tank vent valve is open and the line between tank vent valve 3 and check valve 51 or check valves 51, 52 is intact is defined as lower limiting pressure pₗᵤ. If pressure pₗ is less than or equal to lower limiting pressure p₁ᵤ and greater than pressure pᵥ at Venturi nozzle 46, it is established that the line between tank vent valve 3 and Venturi nozzle 46 is not defective. For a starting state in which pressure p₂ is greater than ambient pressure pᵤ, tank vent valve 3 is opened briefly one time. Pressure p₁ then increases, either from the value that is stored as intake manifold pressure p₂ (less than ambient pressure pᵤ) or from pressure pᵥ at Venturi nozzle 46, to lower limiting pressure p₁ᵤ until tank vent valve 3 is reclosed. If pressure p₁ does not subsequently drop back to the value of pressure pᵥ at Venturi nozzle 46, it is established that the line between tank vent valve 3 and Venturi nozzle 46 is defective.

Lastly, according to the present invention the functioning of check valves 51, 52 may also be checked. For this purpose, tank vent valve 3 is closed, and lowest intake manifold pressure p₂ remains enclosed as pressure pₗ in the line between tank vent valve 3 and check valve 51 or check valves 51, 52. For loads in which p₂>pᵤ, in the specific embodiment according to FIG. 3, lowest pressure pᵥ that is generatable by Venturi nozzle 46 remains stored. A check as to whether pressure p₁ may be maintained for a preset time period when pressure p₂ once again increases above pressure pₗ may be made immediately following the start of internal combustion engine 41. Shortly before internal combustion engine 41 is switched off, for example when a switchover is made to electric driving mode in a hybrid vehicle, tank vent valve 3 is quickly closed, so that for a pressure p₂ which is less than ambient pressure pᵤ, pressure p₂ may be stored as pressure pₗ. Tank vent valve 3 is kept closed for the stop phase of internal combustion engine 41, for example during control unit overrun, and a measurement is made of how quickly pressure p₁ increases to ambient pressure pᵤ. If pressure pₗ is maintained for a preset time period, it may be established that check valves 51, 52 are not defective. If tank vent valve 3 is briefly reopened during the stop phase or during control unit overrun, based on the change in pressure p₁ to ambient pressure pᵤ it may be deduced that tank vent valve 3 is functioning. When internal combustion engine 41 is started, the starting diagnosis described above may subsequently be begun. In contrast, if negative pressure p₁ is not maintained, and the check of tank vent valve 3 and the check of the lines has already been completed, it having been established that tank vent valve 3 and the lines are not defective, the curve of pressure p₁ with respect to pressure p₂ is subsequently analyzed with the tank vent valve closed. If pressure p₁ always corresponds to pressure p₂ in operating range p₂<pᵤ, check valve 51 is defective. If pressure pₗ is also greater than pᵤ when p₂>pᵤ, it may also be deduced that check valve 51 is defective. In contrast, if pressure pₗ is always greater than p₂ in range p₂<pᵤ, and adapts to a value greater than p₁ᵤ when p₂>pᵤ and tank vent valve 3 is open, and when tank vent valve is closed, adapts to pressure pᵥ at Venturi nozzle 46 and this negative pressure is maintained even when tank vent valve 3 is closed, if pressure p₂ once again drops but does not go below ambient pressure pᵤ, check valve 51 is operating properly and check valve 52 is defective.

All method steps according to the present invention may be executed by a computer program which runs on a computer or control unit that is connected to the tank venting system. A computer program product having program code, stored on a machine-readable medium, is used for carrying out the method according to the present invention when the program is executed on a computer or control unit. It is thus easily possible to implement the method according to the present invention in a control unit.

1-10. (canceled)

11. A tank venting system for an internal combustion engine having an intake manifold, a fuel tank, and an activated carbon filter, the system comprising:
a tank vent valve situated in a line connecting the activated carbon filter to the intake manifold;
at least one check valve situated in the line between the tank vent valve and the intake manifold; and
a pressure sensor situated in the line between the tank vent valve and the check valve.

12. A method for diagnosing the tank vent valve in the tank venting system as recited in claim 11, the method comprising:
storing between the tank vent valve and the check valve a first pressure which is less than the ambient pressure outside the tank venting system;
changing the first pressure by controlling the tank vent valve; and
measuring, via the pressure sensor, the change in the first pressure between the tank vent valve and the check valve;
associating the measured change in the first pressure with the control of the tank vent valve; and
deducing, based on a correlation of an opening state of the tank vent valve with the measured change in the first pressure between the tank vent valve and the check valve, the functioning of at least one of a tank venting line, the check valve, and the tank vent valve.

13. The method as recited in claim 12, wherein:
while the internal combustion engine is switched off, the tank vent valve is opened and subsequently closed when the first pressure is not equal to the ambient pressure; and
(i) after the tank vent valve is closed, an upward sensor drift is recognized if the first pressure is greater than the sum of the ambient pressure and a predefined error threshold;
(ii) after the tank vent valve is closed, if the first pressure is less than a setpoint pressure which is ascertained over the engine switched-off period on the basis of the difference between the first pressure at the immediately preceding time the internal combustion engine was switched off and the ambient pressure, the curve of the first pressure is measured when the internal combustion engine is started, and a downward sensor drift is recognized if at least one of (a) at any point in time during the starting operation, the first pressure is less than a second pressure in the intake manifold of the internal combustion engine by a predefined error threshold, and (b) at the end of the starting operation, the first pressure is less than a minimum achieved pressure; and
(iii) at the end of the starting operation, the tank vent valve is opened if the second pressure is less than the ambient pressure and jamming of the tank vent valve is deduced if one of no change in the first pressure is measured, or the first pressure remains equal to the minimum achieved pressure since the starting of the engine.

14. The method as recited in claim 13, wherein when the first pressure is not equal to the second pressure in the intake manifold of the internal combustion engine during starting, the following conditions are determined:
a) if the first pressure is equal to the ambient pressure, the line between the pressure sensor and an inlet point of the tank venting line into the intake manifold is determined as being interrupted, and
b) if the first pressure is less than the ambient pressure and greater than the second pressure in the intake manifold, and the first pressure during continued operation of the internal combustion engine is equal to the second pressure plus the predefined error threshold, a lower limiting pressure is defined as the first pressure which is measured at the pressure sensor when the tank vent valve is open and the line between the tank vent valve and the check valve is intact, and an upper limiting pressure is defined as the first pressure which is measured at the pressure sensor when the tank vent valve and the check valve are intact but the line between the tank vent valve and the check valve has fallen off, and
b1) if the first pressure is no greater than the upper limiting pressure and greater than the lower limiting pressure, the pressure line between the pressure sensor and the tank vent valve is recognized as being defective;
b2) if the first pressure is no greater than the lower limiting pressure and greater than the second pressure in the intake manifold, the tank vent valve is recognized as being open;
b3) if the first pressure is greater than the second pressure in the intake manifold and less than the ambient pressure, in an engine system which has two tank venting inlet points and which includes a full load inlet point, (i) the check valve of the line between the tank vent valve and the full load inlet point is recognized as being defective if a change in pressure occurs when the tank vent valve is energized, and (ii) the pressure line between the pressure sensor and the tank vent valve is recognized as being defective when no pressure jump occurs when the tank vent valve is energized.

15. The method as recited in claim 12, wherein during operation of the internal combustion engine, if the first pressure does not vary when the tank vent valve is opened and closed, a lower limiting pressure is defined as the first pressure which is measured at the pressure sensor when the tank vent valve is open and the line between the tank vent valve and the check valve is intact, and an upper limiting pressure is defined as the first pressure which is measured at the pressure sensor when the tank vent valve and the check valve are intact but the line between the tank vent valve and the check valve has fallen off, and
if the second pressure in the intake manifold is less than the ambient pressure, and
(i) if the tank vent valve has been recognized as defective, the tank vent valve is recognized as being jammed open if the first pressure is no greater than the lower limiting pressure and greater than the second pressure in the intake manifold,
(ii) if a diagnosis of the tank vent valve is not possible, a line defect is recognized if the first pressure is greater than the lower limiting pressure and less than the ambient pressure,
(iii) if the first pressure is no greater than the second pressure in the intake manifold and remains at the minimum achieved value, the tank vent valve is recognized as being jammed shut, or
(iv) if the first pressure is consistently equal to the second pressure in the intake manifold, the check valve is recognized as being defective,
if the second pressure in the intake manifold is greater than the ambient pressure, and
(v) if the first pressure drops with increasing of the second pressure in an engine system which has two tank venting inlet points and which includes a full load inlet point, the tank vent valve is recognized as being jammed open if the first pressure is not greater than the lower limiting pressure and greater than the pressure at the full load inlet point, and the tank vent valve is recognized as being jammed shut if the first pressure is equal to the pressure at the full load inlet point,
(vi) if the first pressure is equal to the ambient pressure when the tank vent valve is open, the line between the pressure sensor and the full load inlet point is recognized as being defective,
(vii) if the first pressure is greater than the ambient pressure, and the first pressure is correlated with the second pressure, the check valve is recognized as being defective, and
(viii) if the first pressure is greater than the lower limiting pressure and no greater than the upper limiting pressure, the line between the tank vent valve and the pressure sensor is recognized as being defective.

16. The method as recited in claim 12, wherein during operation of the internal combustion engine,
when the tank vent valve is closed, the first pressure is no greater than the second pressure in the intake manifold, and the second pressure is less than the ambient pressure,
(i) a falling off of the line is recognized if the first pressure is equal to the ambient pressure,
(ii) a downward sensor drift is recognized if the first pressure is continuously less than the second pressure by an offset, and
(iii) the check valve is recognized as being jammed open if the first pressure is equal to the second pressure with increasing of the second pressure,
when the tank vent valve is open, a lower limiting pressure is defined as the first pressure which is measured at the pressure sensor when the tank vent valve and the line between the tank vent valve and the check valve is intact, and an upper limiting pressure is defined as the first pressure which is measured at the pressure sensor when the tank vent valve and the check valve are intact but the line between the tank vent valve and the check valve has fallen off, and
(i) the line between the tank vent valve and the pressure sensor is recognized as having fallen off if the first pressure is greater than the lower limiting pressure and no greater than the upper limiting pressure, and
(ii) the line between the pressure sensor and a tank venting inlet point is recognized as having fallen off if the first pressure is equal to the ambient pressure.

17. The method as recited in claim 12, wherein during operation of the internal combustion engine, during the transition of the second pressure in the intake manifold from a value less than the ambient pressure to a value greater than the ambient pressure, the tank vent valve is opened until the first pressure corresponds to the ambient pressure, and a defect in the line between the tank vent valve and a full load inlet point is recognized if the first pressure does not fall below the ambient pressure after the tank vent valve is closed.

18. The method as recited in claim 15, wherein prior to switching off the internal combustion engine, the tank vent valve is closed in order to store the second pressure in the intake manifold as the first pressure between the tank vent valve and the check valve, and after closing of the tank vent valve, an increase in the first pressure is measured and the tank vent valve and the lines have been assessed as defect-free,
(i) the check valve of an inlet point into the intake manifold is recognized as being defective if the first pressure is consistently equal to the first pressure and the second pressure is less than the ambient pressure,
(ii) the check valve of the full load inlet point is recognized as being defective if the first pressure is always greater than the second pressure by an offset and the second pressure is less than the ambient pressure, and when the second pressure is greater than the ambient pressure, the first pressure remains constant when the second pressure drops.

19. A non-transitory computer-readable data storage medium storing a computer program having program codes which, when executed on a computer, perform a method for diagnosing the tank vent valve in the tank venting system as recited in claim 11, the method comprising:
storing between the tank vent valve and the check valve a first pressure which is less than the ambient pressure outside the tank venting system;
changing the first pressure by controlling the tank vent valve; and
measuring, via the pressure sensor, the change in the first pressure between the tank vent valve and the check valve;
associating the measured change in the first pressure with the control of the tank vent valve; and
deducing, based on a correlation of an opening state of the tank vent valve with the measured change in the first pressure between the tank vent valve and the check valve, the functioning of at least one of a tank venting line, the check valve, and the tank vent valve.
